(19) United States
(12) Patent Application Publication
(10) Pub. No.: US 2012/0307795 A1
(43) Pub. Date: Dec. 6, 2012

(54) MOBILE COMMUNICATION METHOD AND GATEWAY DEVICE

(75) Inventors: Hideaki Takahashi, Yokohama-shi (JP); Wuri Andarmawanti Hapsari, Yokosuka-shi (JP); Takeshi Okamoto, Yokosuka-shi (JP); Mikio Iwamura, Minato-ku (JP); Minami Ishii, Yokohama-shi (JP)

(73) Assignee: NTT DOCOMO, INC., Tokyo (JP)

(21) Appl. No.: 13/513,775

(22) PCT Filed: Dec. 3, 2010
(86) PCT No.: PCT/JP2010/071716

§ 371 Date: Aug. 14, 2012

(30) Foreign Application Priority Data
Dec. 4, 2009 (JP) 2009-276885

(51) Int. Cl. H04W 36/08; H04W 88/16

(52) U.S. Cl. 370/331

(57) ABSTRACT

A handover method according to the present invention includes a step of transmitting, by a radio base station HeNB#1, “HO Request” to a gateway device HeNB-GW#1, the “HO Request” including “Target CGI” capable of uniquely designating a cell #2 and “TAI” capable of designating a tracking area to which the cell #2 belongs, and a step of transmitting, by the gateway device HeNB-GW#1, “HO Request” including the “Target CGI” to a gateway device HeNB-GW#2 designated by an IP address corresponding to the “TAI”.

### TECHNICAL FIELD

The present invention relates to a mobile communication method and a gateway device.

### BACKGROUND ART

In an LTE (Long Term Evolution) mobile communication system is configured to include a gateway device HeNB-GW capable of accommodating one or a plurality of radio base stations HeNB (Home-eNB).

### SUMMARY OF THE INVENTION

### Problems to be Solved by the Invention

However, there is a problem in the mobile communication system that when a radio base station HeNB managing a handover destination cell and a radio base station HeNB managing a handover source cell are accommodated in different gateway devices HeNB-GW, since all handover-related control signals are used in a handover using an “S1 application protocol” via a mobile switching center MME (Mobility Management Entity), it is not possible to reduce a processing load of the control signals of the mobile switching center MME.

Therefore, the present invention has been achieved in view of the above-described problems, and an object thereof is to provide a mobile communication method and a gateway device, by which it is possible to reduce handover control in which a mobile switching center MME is involved and to directly perform handover control between different gateway devices HeNB-GW, even when a radio base station HeNB managing a handover destination cell and a radio base station HeNB managing a handover source cell are accommodated in the different gateway devices HeNB-GW.

### Means for Solving the Problem

A first characteristic of the present embodiment is summarized in that a method, which allows a handover of a mobile station from a first cell subordinate to a first radio base station accommodated in a first gateway device to a second cell subordinate to a second radio base station accommodated in a second gateway device, the method comprising, a step of transmitting, by the first radio base station, a handover request signal to the first gateway device, the handover request signal including a cell identifier capable of uniquely designating the second cell and a tracking area identifier capable of designating a tracking area to which the second cell belongs, a step of transmitting, by the first gateway device, a handover request signal including the cell identifier to the second gateway device designated by an IP address corresponding to the tracking area identifier, and a step of transmitting, by the second gateway device, a handover request signal including the cell identifier to the second radio base station designated by an IP address corresponding to the cell identifier.

A second characteristic of the present embodiment is summarized in that a method, which allows a handover of a mobile station from a first cell subordinate to a first radio base station accommodated in a first gateway device to a second cell subordinate to a second radio base station accommodated in a second gateway device, the method comprising, a step of transmitting, by the first radio base station, a handover request signal to the first gateway device, the handover request signal including a cell identifier capable of uniquely designating the second cell, a step of transmitting, by the first gateway device, a handover request signal including the cell identifier to the second gateway device designated by an IP address corresponding to the cell identifier, and a step of transmitting, by the second gateway device, a handover request signal including the cell identifier to the second radio base station designated by an IP address corresponding to the cell identifier.

A third characteristic of the present embodiment is summarized in that a gateway device, which serves as a first gateway device in a method for allowing a handover of a mobile station from a first cell subordinate to a first radio base station accommodated in the first gateway device to a second cell subordinate to a second radio base station accommodated in a second gateway device, comprising, a reception unit configured to receive a handover request signal from the first radio base station, the handover request signal including a cell identifier capable of uniquely designating the second cell and a tracking area identifier capable of designating a tracking area to which the second cell belongs; and a transmission unit configured to transmit a handover request signal including the cell identifier to the second gateway device designated by an IP address corresponding to the tracking area identifier.

A fourth characteristic of the present embodiment is summarized in that A gateway device, which serves as a first gateway device in a method for allowing a handover of a mobile station from a first cell subordinate to a first radio base station accommodated in the first gateway device to a second cell subordinate to a second radio base station accommodated in a second gateway device, comprising, a reception unit configured to receive a handover request signal from the first radio base station, the handover request signal including a cell identifier capable of uniquely designating the second cell, and a transmission unit configured to transmit a handover request signal including the cell identifier to the second gateway device designated by an IP address corresponding to the cell identifier.

### Effect of the Invention

As described above, in accordance with the present invention, it is possible to provide a mobile communication method and a gateway device, by which it is possible to reduce handover control in which a mobile switching center MME is involved and to directly perform handover control between the different gateway devices HeNB-GW even when a radio base station HeNB managing a handover destination cell and a radio base station HeNB managing a handover source cell are accommodated in different gateway devices HeNB-GW.

### BRIEF DESCRIPTION OF THE DRAWINGS

FIG. 1 is a diagram showing the entire configuration of a mobile communication system according to a first embodiment of the present invention.

FIG. 2 is a functional block diagram of a gateway device according to the first embodiment of the present invention.

FIG. 3 is a diagram illustrating an example of information elements of “Handover Request” transmitted in the mobile communication system according to the first embodiment of the present invention.

FIG. 4 is a diagram explaining the operation of the mobile communication system according to the first embodiment of the present invention.

FIG. 5 is a diagram explaining the operation of a mobile communication system according to a second embodiment of the pre sent invention.

### BEST MODES FOR CARRYING OUT THE INVENTION

### (Mobile Communication System According to First Embodiment of the Present Invention)

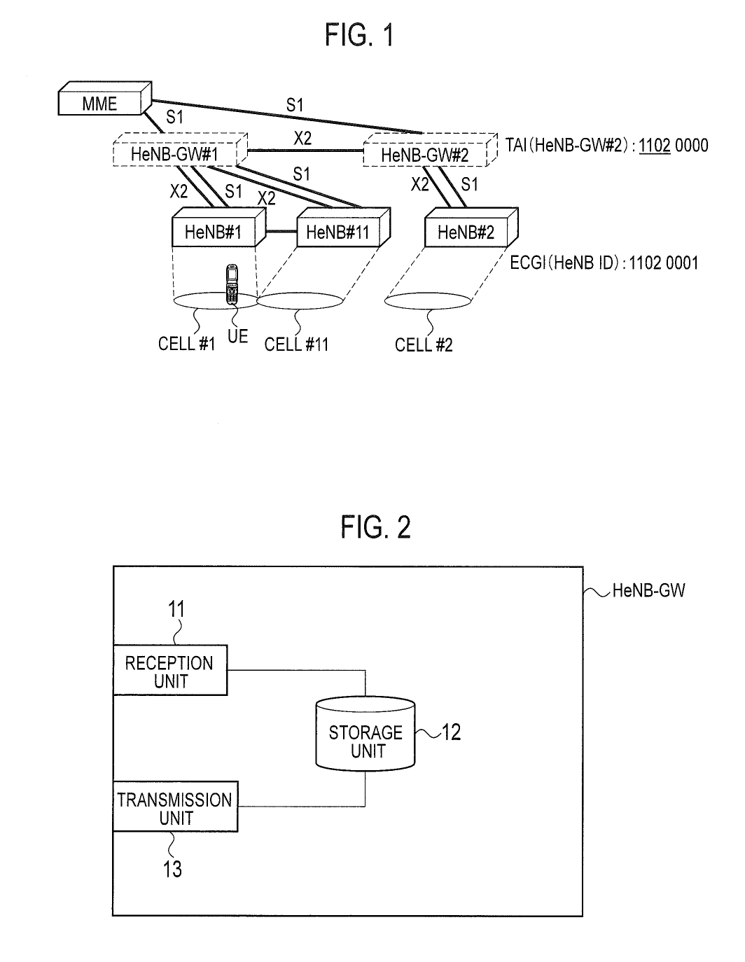

With reference to FIG. 1 to FIG. 4, a mobile communication system according to a first embodiment of the present invention will be described.

The mobile communication system according to the present embodiment is an LTE mobile communication system, and includes a mobile switching center MME, gateway devices HeNB-GW#1/HeNB-GW#2, radio base stations HeNB#1/HeNB#11/HeNB#2, and a mobile station UE as illustrated in FIG. 1.

As illustrated in FIG. 1, the radio base stations HeNB#1/HeNB#11 are accommodated in the gateway device HeNB-GW#1, and the radio base station HeNB#2 is accommodated in the gateway device HeNB-GW#2.

Furthermore, a cell #1 is provided subordinate to the radio base station HeNB#1, a cell #11 is provided subordinate to the radio base station HeNB#11, and a cell #2 is provided subordinate to the radio base station HeNB#2.

Furthermore, the gateway device HeNB-GW#1 and the gateway device HeNB-GW#2 are connected to each other through an X2 interface, the gateway device HeNB-GW#1 and the mobile switching center MME are connected to each other through an S1 interface, and the gateway device HeNB-GW#2 and the mobile switching center MME are connected to each other through the S1 interface.

Furthermore, the gateway device HeNB-GW#1 and the radio base stations HeNB#1/HeNB#11 are connected to each other through the X2 interface and the S1 interface, and the gateway device HeNB-GW#2 and the radio base station HeNB#2 are connected to each other through the X2 interface and the S1 interface.

Hereinafter, a description will be provided for a case in which the mobile station UE is handed over from the cell #1 to the cell #2 in the mobile communication system according to the present embodiment.

As illustrated in FIG. 2, a gateway device HeNB-GW (the gateway device HeNB-GW#1 in the present embodiment) according to the present embodiment includes a reception unit 11, a storage unit 12, and a transmission unit 13.

The reception unit 11 is configured to receive “(X2) HO Request” from the radio base station HeNB#1 managing a handover source cell (the cell #1 in the present embodiment), wherein the “(X2) HO Request” includes “Target CGI (Cell Global Identity)=11020001” capable of uniquely designating the cell #2, and “TAI (Tracking Area Identity)=1200” capable of designating a tracking area to which the cell #2 belongs.

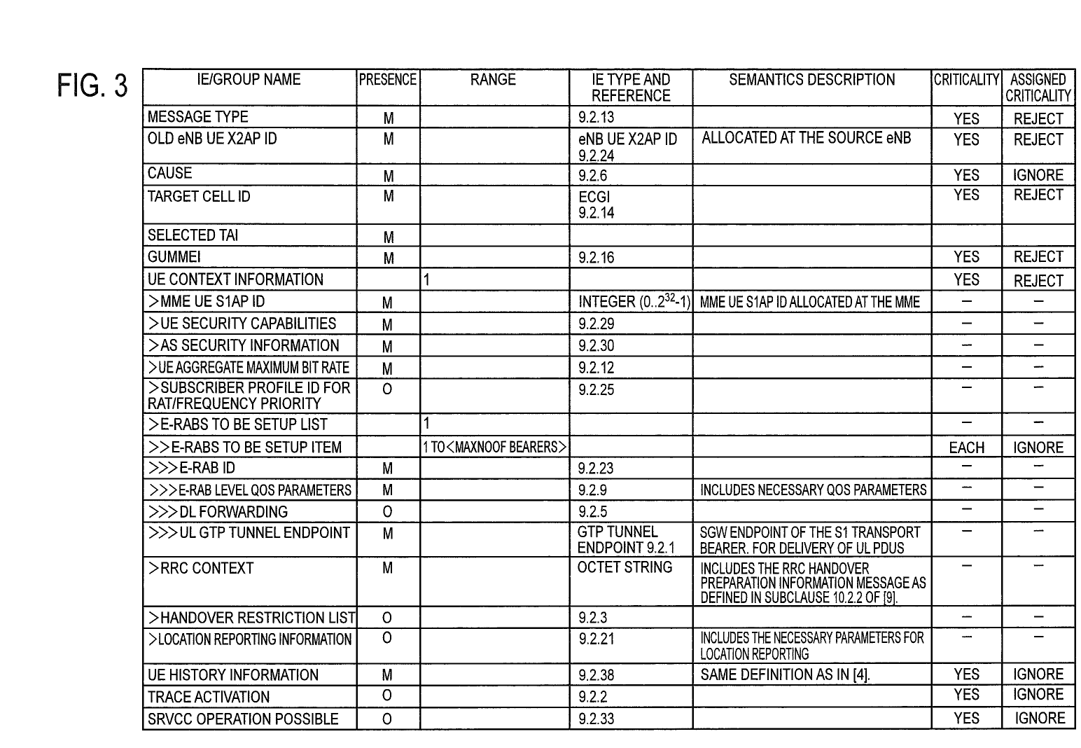

FIG. 3 illustrates an example of information elements of “Handover Request” received in the reception unit 11.

As illustrated in FIG. 3, “Target Cell ID”, “Selected TAI” and the like may be set in the “Handover Request” as information elements.

Here, the “Target Cell ID” denotes “ECGI” of a handover destination cell (the cell #2 in the present embodiment), and the “Selected TAI” denotes “TAI” capable of designating a tracking area to which the handover destination cell (the cell #2 in the present embodiment) belongs.

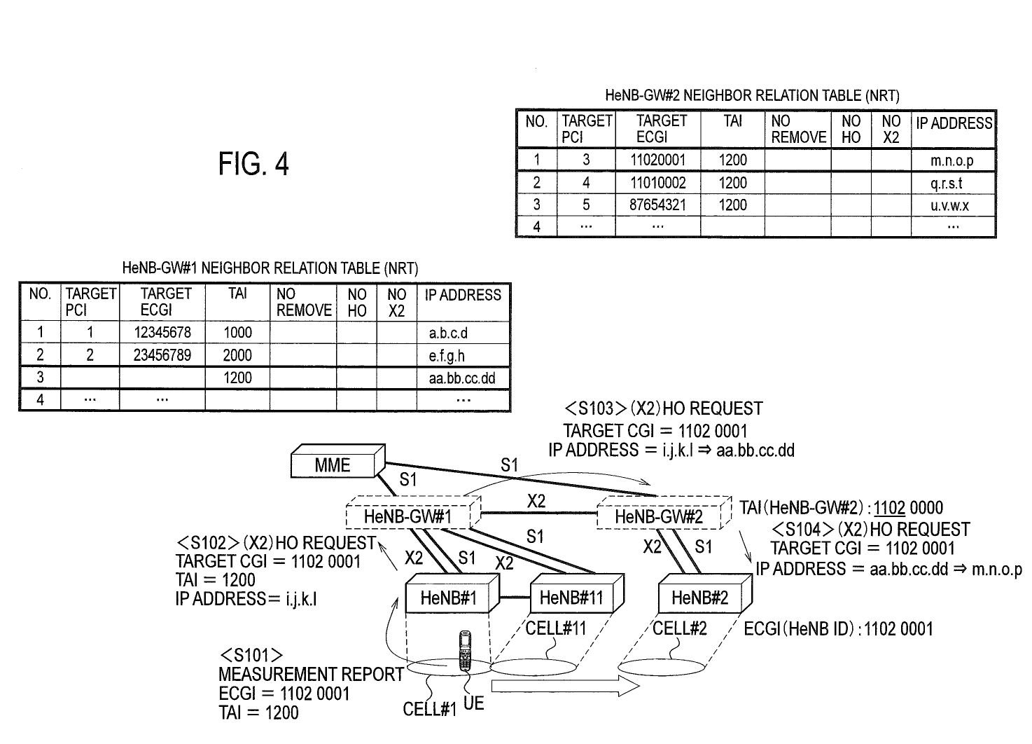

The storage unit 12 is configured to store “NRT (Neighbor Relation Table)” as illustrated in FIG. 4. For example, as illustrated in FIG. 4, the “NRT” stores “Target PCI (Physical Cell Identity)”, “Target ECGI (Enhanced CGI)”, the “TAI”, an “IP address” and the like for each cell subordinate to adjacent radio base stations HeNB.

The transmission unit 13 is configured to transmit “(X2) HO Request”, which includes the “Target CGI=11020001” included in the “(X2) HO Request” received by the reception unit 11, to the gateway device HeNB-GW#2 designated by an IP address “aa.bb.cc.dd” corresponding to the “TAI=1200” included in the “(X2) HO Request” received by the reception unit 11.

Hereinafter, with reference to FIG. 4, a description will be provide for the operation of the mobile communication system according to the first embodiment of the present invention, specifically, an operation when the mobile station UE performs an X2 handover from the cell #1 to the cell #2 in the mobile communication system according to the first embodiment of the present invention.

As illustrated in FIG. 4, in step S101, the mobile station UE during communication in the cell #1 transmits “Measurement Report” to the radio base station HeNB#1, wherein the “Measurement Report” includes the “Target CGI=11020001” capable of uniquely designating the cell #2, and the “TAI=1200” capable of designating the tracking area to which the cell #2 belongs.

In step S102, if it is determined that the mobile station UE performs the X2 handover procedure from the cell #1 to the cell #2, the radio base station HeNB#1 transmits “(X2) HO Request” to the gateway device HeNB-GW#1, which is designated by an IP address “i.j.k.l”, through the X2 interface, wherein the “(X2) HO Request” includes the “Target CGI=11020001” capable of uniquely designating the cell #2, and the “TAI=1200” capable of designating the tracking area to which the cell #2 belongs.

Here, the radio base station HeNB#1 is configured to transmit the “(X2) HO Request” to the gateway device HeNB-GW#1 without using “Target CGI” capable of uniquely designating the handover destination cell.

In step S103, the gateway device HeNB-GW#1 extracts the IP address “aa.bb.cc.dd” with reference to NRT (HeNB-GW#1 Neighbor Relation Table), wherein the IP address “aa.bb.cc.dd” corresponds to the “TAI=1200” capable of designating the tracking area to which the cell #2 belongs.

Then, the gateway device HeNB-GW#1 transmits “(X2) HO Request” to the gateway device HeNB-GW#2, which is designated by the IP address “aa.bb.cc.dd”, through the X2 interface, wherein the “(X2) HO Request” includes the “Target CGI=11020001” capable of uniquely designating the cell #2.

In step S104, the gateway device HeNB-GW#2 extracts an IP address “m.n.o.p” with reference to NRT (HeNB-GW#2 Neighbor Relation Table), wherein the IP address “m.n.o.p” corresponds to the “Target CGI=11020001” capable of uniquely designating the cell #2.

Then, the gateway device HeNB-GW#2 transmits “(X2) HO Request” to the radio base station HeNB#2, which is designated by the IP address “m.n.o.p”, through the X2 interface, wherein the “(X2) HO Request” includes the “Target CGI=11020001” capable of uniquely designating the cell #2.

Thereafter, the X2 handover procedure of the mobile station UE from the cell #1 to the cell #2 is continued.

In accordance with the mobile communication system according to the first embodiment of the present invention, since the radio base station HeNB#1 managing the cell #1 (the handover source cell) is configured to transmit the “(X2) HO Request”, which includes the “TAI” capable of designating the tracking area to which the cell #2 belongs, to the gateway device HeNB-GW#1, it is possible for the gateway device HeNB-GW#1, by using the “TAI”, to transmit the “(X2) HO Request” to the gateway device HeNB-GW#2 accommodating the radio base station HeNB#2 managing the cell #2 (the handover destination cell).

As a consequence, even when the radio base station HeNB managing the handover destination cell and the radio base station HeNB managing the handover source cell are accommodated in different gateway devices HeNB-GW, it is possible to perform the X2 handover.

(Mobile Communication System According to Second Embodiment of the Present Invention)

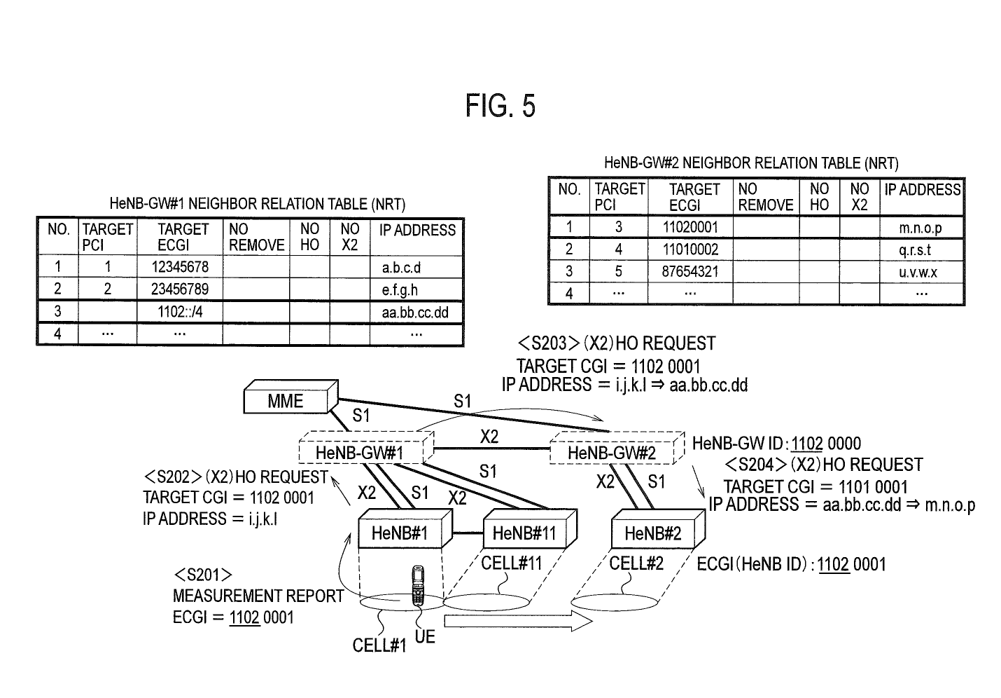

With reference to FIG. 5, a mobile communication system according to a second embodiment of the present invention will be described. Hereinafter, the mobile communication system according to the second embodiment of the present invention will be described while focusing on the difference from the mobile communication system according to the first embodiment as described above.

Hereinafter, with reference to FIG. 5, a description will be provide for the operation of the mobile communication system according to the second embodiment of the present invention, specifically, an operation when the mobile station UE performs the X2 handover from the cell #1 to the cell #2 in the mobile communication system according to the second embodiment of the present invention.

As illustrated in FIG. 5, in step S201, the mobile station UE during communication in the cell #1 transmits the “Measurement Report” to the radio base station HeNB#1, wherein the “Measurement Report” includes the “Target CGI=11020001” capable of uniquely designating the cell #2.

In step S202, if it is determined that the mobile station UE performs the X2 handover procedure from the cell #1 to the cell #2, the radio base station HeNB#1 transmits “(X2) HO Request” to the gateway device HeNB-GW#1, which is designated by the IP address “i.j.k.l”, through the X2 interface, wherein the “(X2) HO Request” includes the “Target CGI=11020001” capable of uniquely designating the cell #2.

Here, the radio base station HeNB#1 is configured to transmit the “(X2) HO Request” to the gateway device HeNB-GW#1 without using the “Target CGI” capable of uniquely designating the handover destination cell.

In step S203, the gateway device HeNB-GW#1 extracts the IP address “aa.bb.cc.dd” with reference to NRT (HeNB-GW#1 Neighbor Relation Table), wherein the IP address “aa.bb.cc.dd” corresponds to the “Target CGI=11020001” capable of uniquely designating the cell #2.

Here, as illustrated in FIG. 5, in the “Target ECGI” of the NRT (HeNB-GW#1 Neighbor Relation Table), information “1102: :14” for defining a subnet prefix “1102” of the “ECGI” of the handover destination cell has been set.

Thus, specifically, the gateway device HeNB-GW#1 extracts the IP address “aa.bb.cc.dd” with reference to the NRT (HeNB-GW#1 Neighbor Relation Table), wherein the IP address “aa.bb.cc.dd” corresponds to the subnet prefix “1102” of the “Target CGI=11020001” capable of uniquely designating the cell #2.

Then, the gateway device HeNB-GW#1 transmits “(X2) HO Request” to the gateway device HeNB-GW#2, which is designated by the IP address “aa.bb.cc.dd”, through the X2 interface, wherein the “(X2) HO Request” includes the “Target CGI=11020001” capable of uniquely designating the cell #2.

In step S204, the gateway device HeNB-GW#2 extracts the IP address “m.n.o.p” with reference to NRT (HeNB-GW#2 Neighbor Relation Table), wherein the IP address “m.n.o.p” corresponds to the “Target CGI=11020001” capable of uniquely designating the cell #2.

Then, the gateway device HeNB-GW#2 transmits “(X2) HO Request” to the radio base station HeNB#2, which is designated by the IP address “m.n.o.p”, through the X2 interface, wherein the “(X2) HO Request” includes the “Target CGI=11020001” capable of uniquely designating the cell #2.

Thereafter, the X2 handover procedure of the mobile station UE from the cell #1 to the cell #2 is continued.

In accordance with the mobile communication system according to the second embodiment of the present invention, the gateway device HeNB-GW#1 transmits the “(X2) HO Request” including the “Target CGI=11020001” to an IP address corresponding to the subnet prefix “1102” of the “Target CGI=11020001” included in the “(X2) HO Request” received from the radio base station HeNB#1, so that it is possible for the gateway device HeNB-GW#1 to transmit the “(X2) HO Request” to the gateway device HeNB-GW#2 accommodating the radio base station HeNB#2 managing the cell #2 (the handover destination cell).

As a consequence, even when the radio base station HeNB managing the handover destination cell and the radio base station HeNB managing the handover source cell are accommodated in different gateway devices HeNB-GW, it is possible to perform the X2 handover.

The characteristics of the present embodiment as described above may be expressed as follows.

A first characteristic of the present embodiment is summarized in that a method, which allows a handover of a mobile station UE from a cell #1 (a first cell) subordinate to a radio base station HeNB#1 (a first radio base station) accommodated in a gateway device HeNB-GW#1 (a first gateway device) to a cell #2 (a second cell) subordinate to a radio base station HeNB#2 (a second radio base station) accommodated in a gateway device HeNB-GW#2 (a second gateway device), includes: a step of transmitting, by the radio base station HeNB#1, “(X2) HO Request (a handover request signal)” to the gateway device HeNB-GW#1, the “(X2) HO Request” including “Target CGI (a cell identifier)=11020001” capable of uniquely designating the cell #2 and “TAI (a tracking area identifier)=1200” capable of designating a tracking area to which the cell #2 belongs; a step of transmitting, by the gateway device HeNB-GW#1, “(X2) HO Request (a handover request signal)” including the “Target CGI=11020001” to the gateway device HeNB-GW#2 designated by an IP address “aa.bb.cc.dd” corresponding to the “TAI=1200”; and a step of transmitting, by the gateway device HeNB-GW#2, “(X2) HO Request (a handover request signal)” including the “Target CGI=11020001” to the radio base station HeNB#2 designated by an IP address “m.n.o.p” corresponding to the “Target CGI=11020001”.

A second characteristic of the present embodiment is summarized in that a method, which allows a handover of a mobile station UE from a cell #1 subordinate to a radio base station HeNB#1 accommodated in a gateway device HeNB-GW#1 to a cell #2 subordinate to a radio base station HeNB#2 accommodated in a gateway device HeNB-GW#2, includes: a step of transmitting, by the radio base station HeNB#1, “(X2) HO Request” to the gateway device HeNB-GW#1, the “(X2) HO Request” including “Target CGI=11020001” capable of uniquely designating the cell #2; a step of transmitting, by the gateway device HeNB-GW#1, “(X2) HO Request” including the “Target CGI=11020001” to the gateway device HeNB-GW#2 designated by an IP address “aa.bb.cc.dd” corresponding to the “Target CGI=11020001”; and a step of transmitting, by the gateway device HeNB-GW#2, “(X2) HO Request” including the “Target CGI=11020001” to the radio base station HeNB#2 designated by an IP address “m.n.o.p” corresponding to the “Target CGI=11020001”.

A third characteristic of the present embodiment is summarized in that a gateway device HeNB-GW, which serves as a gateway device HeNB-GW#1 in a method for allowing a handover of a mobile station UE from a cell #1 subordinate to a radio base station HeNB#1 accommodated in the gateway device HeNB-GW#1 to a cell #2 subordinate to a radio base station HeNB#2 accommodated in a gateway device HeNB-GW#2, includes: a reception unit 11 configured to receive “(X2) HO Request” from the radio base station HeNB#1, the “(X2) HO Request” including “Target CGI=11020001” capable of uniquely designating the cell #2 and “TAI=1200” capable of designating a tracking area to which the cell #2 belongs; and a transmission unit 13 configured to transmit “(X2) HO Request” including the “Target CGI=11020001” to the gateway device HeNB-GW#2 designated by an IP address “aa.bb.cc.dd” corresponding to the “TAI=1200”.

A fourth characteristic of the present embodiment is summarized in that a gateway device HeNB-GW, which serves as a gateway device HeNB-GW#1 in a method for allowing a handover of a mobile station UE from a cell #1 subordinate to a radio base station HeNB#1 accommodated in the gateway device HeNB-GW#1 to a cell #2 subordinate to a radio base station HeNB#2 accommodated in a gateway device HeNB-GW#2, includes: a reception unit 11 configured to receive “(X2) HO Request” from the radio base station HeNB#1, the “(X2) HO Request” including “Target CGI=11020001” capable of uniquely designating the cell #2; and a transmission unit 13 configured to transmit “(X2) HO Request” including the “Target CGI=11020001” to the gateway device HeNB-GW#2 designated by an IP address “aa.bb.cc.dd” corresponding to the “Target CGI=11020001”.

It is noted that the operation of the above-described the mobile switching center MME, the radio base station HeNB, the gateway device HeNB-GW or the mobile station UE may be implemented by a hardware, may also be implemented by a software module executed by a processor, and may further be implemented by the combination of the both.

The software module may be arranged in a storage medium of an arbitrary format such as RAM (Random Access Memory), a flash memory, ROM (Read Only Memory), EPROM (Erasable Programmable ROM), EEPROM (Electronically Erasable and Programmable ROM), a register, a hard disk, a removable disk, and CD-ROM.

The storage medium is connected to the processor so that the processor can write and read information into and from the storage medium. Such a storage medium may also be accumulated in the processor. The storage medium and processor may be arranged in ASIC. Such the ASIC may be arranged in the mobile switching center MME, the radio base station HeNB, the gateway device HeNB-GW or the mobile station UE. Further, such a storage medium or a processor may be arranged, as a discrete component, in the mobile switching center MME, the radio base station HeNB, the gateway device HeNB-GW or the mobile station UE.

Thus, the present invention has been explained in detail by using the above-described embodiments; however, it is obvious that for persons skilled in the art, the present invention is not limited to the embodiments explained herein. The present invention can be implemented as a corrected and modified mode without departing from the gist and the scope of the present invention defined by the claims. Therefore, the description of the specification is intended for explaining the example only and does not impose any limited meaning to the present invention.

### INDUSTRIAL APPLICABILITY

As described above, in accordance with the present invention, it is possible to provide a mobile communication method and a gateway device, by which it is possible to reduce handover control in which a mobile switching center MME is involved and to directly perform handover control between the different gateway devices HeNB-GW even when a radio base station HeNB managing a handover destination cell and a radio base station HeNB managing a handover source cell are accommodated in different gateway devices HeNB-GW.

### DESCRIPTION OF THE REFERENCE NUMERALS

MME . . . Mobile switching center
HeNB . . . Radio base station
HeNB-GW . . . Gateway device
11 . . . Reception unit
12 . . . Storage unit
13 . . . Transmission unit
UE . . . Mobile station

1. A method, which allows a handover of a mobile station from a first cell subordinate to a first radio base station accommodated in a first gateway device to a second cell subordinate to a second radio base station accommodated in a second gateway device, the method comprising:
a step of transmitting, by the first radio base station, a handover request signal via X2 interface to the first gateway device, the handover request signal including a cell identifier capable of uniquely designating the second cell and a tracking area identifier capable of designating a tracking area to which the second cell belongs;
a step of transmitting, by the first gateway device, a handover request signal including the cell identifier via X2 interface to the second gateway device designated by the tracking area identifier; and
a step of transmitting, by the second gateway device, a handover request signal including the cell identifier via X2 interface to the second radio base station designated by the cell identifier.

2. A method, which allows a handover of a mobile station from a first cell subordinate to a first radio base station accommodated in a first gateway device to a second cell subordinate to a second radio base station accommodated in a second gateway device, the method comprising:
a step of transmitting, by the first radio base station, a handover request signal via X2 interface to the first gateway device, the handover request signal including a cell identifier capable of uniquely designating the second cell;
a step of transmitting, by the first gateway device, a handover request signal including the cell identifier via X2 interface to the second gateway device designated by the cell identifier; and
a step of transmitting, by the second gateway device, a handover request signal including the cell identifier via X2 interface to the second radio base station designated by the cell identifier.

3. A gateway device, which serves as a first gateway device in a method for allowing a handover of a mobile station from a first cell subordinate to a first radio base station accommodated in the first gateway device to a second cell subordinate to a second radio base station accommodated in a second gateway device, comprising:
a reception unit configured to receive a handover request signal via X2 interface from the first radio base station, the handover request signal including a cell identifier capable of uniquely designating the second cell and a tracking area identifier capable of designating a tracking area to which the second cell belongs; and a transmission unit configured to transmit a handover request signal including the cell identifier via X2 interface to the second gateway device designated by the tracking area identifier.

4. A gateway device, which serves as a first gateway device in a method for allowing a handover of a mobile station from a first cell subordinate to a first radio base station accommodated in the first gateway device to a second cell subordinate to a second radio base station accommodated in a second gateway device, comprising:
a reception unit configured to receive a handover request signal via X2 interface from the first radio base station, the handover request signal including a cell identifier capable of uniquely designating the second cell; and
a transmission unit configured to transmit a handover request signal including the cell identifier via X2 interface to the second gateway device designated by the cell identifier.
